(19) United States
(12) Patent Application Publication
(10) Pub. No.: US 2003/0169970 A1
(43) Pub. Date: Sep. 11, 2003

(54) Photonic signal transmitting device

(76) Inventors: Michael Bazylenko, Eveleigh NSW (AU); Stanislav Petrovich Tarnavskii, Eveleigh NSW (AU)

Correspondence Address: Richard J. Streit, Ladas & Parry, 224 South Michigan Avenue, Suite 1200, Chicago, IL, 60604, US

(21) Appl. No.: 09/900,418

(22) Filed: Jul. 6, 2001

(51) Int. Cl. G02B 6/26

(52) U.S. Cl. 385/50; 385/43

(57) ABSTRACT

A photonic signal transmitting device which comprises a first waveguide having a first core composed of a first material having a refractive index n₁ and a second waveguide having a second core composed of a second material having an average refractive index n₂>n₁. The second core projects into the first core and is formed such that the effective refractive index of the device increases with progression into the second core from the first core. The effective refractive index of the device may be increased by forming the second core with a region which is tapered to provide an increasing cross-sectional area with progression into the second core. The effective refractive index of the device may also be increased by forming the second core such that its composition changes to increase the refractive index with progression into the second core.

### FIELD OF THE INVENTION

A photonic signal transmitting device which incorporates a plurality of waveguides having different characteristics and which facilitates coupling of a photonic signal from one to the other or another of the waveguides.

### BACKGROUND OF THE INVENTION

It is known that photonic signals can be transferred from one waveguide to another simply by aligning the ends on the waveguides end to end. This is referred to as “butt coupling” which is adequate where the waveguides being connected have similar cross-sectional dimensions and similar refractive indices. However, if the cross-sectional dimensions and/or refractive indices of the waveguides being connected are dissimilar, optical losses and, possibly, reflections at the interface between the two waveguides will occur. If the mismatch in refractive index and cross-sectional dimensions are sufficiently large, the transfer of a photonic signal from one waveguide to the other will be very inefficient.

It is known that the coupling of dissimilar waveguides can be achieved by tapering one of the waveguides. In this context, reference may be made to U.S. Pat. No. 5,563,979, dated Oct. 8, 1996, which discloses a planar laser device which comprises an optical coupler for coupling two planar waveguides. Both waveguides are composed of the same type of material (silica- or germanium-based) and have refractive indices which differ by only ˜0.05. One waveguide is doped and has a slightly higher refractive index. This doped, active, waveguide is located upon the other, passive, waveguide and includes a region which is tapered in thickness and/or width which allows for an adiabatic transfer of a single-mode photonic signal.

However, in the case of waveguides that axe composed of significantly different types of materials, at least one of two problems may arise. One problem occurs when for example non silica-based materials, such as ferroelectric materials, having relatively large refractive index differences, are coupled with silica-based material. Then, if something approaching adiabatic transfer is required, the tapered region is required to be unacceptably long. This occurs, for example, if a silica waveguide (refractive index ˜1.4) is coupled with a metal-oxide waveguide such as PLZT having a refractive index of 2.4.

Another problem may occur when the ideal material processing conditions of the coupling waveguides are themselves different. High processing temperatures may be required to produce a tapered waveguide in a core composed, for example, of a metal-oxide, but these temperatures may be destructive for the underlying silica.

### SUMMARY OF THE INVENTION

The present invention seeks to solve these problems by providing a photonic signal transmitting device which comprises:

a first waveguide having a first core composed of a first material having a refractive index n₁, and

a second waveguide having a second core composed of a second material having an average refractive index n₂>n₁;

the second core being projected into the first core, and the second core being formed such that the effective refractive index of the device increases with progression into the second core from the first core.

The invention may also be defined in terms of a method of forming a photonic signal transmitting device, the method comprising the steps of:

forming a first waveguide with a first core composed of a first material having a refractive index n₁, and

forming a second waveguide with a second core projecting into the first core, the second core being composed of a second material having an average refractive index n₂>n₁ and being formed such that the effective refractive index of the device increases with progression from the second core into the first core.

The second waveguide may be formed either prior to or simultaneously with the formation of the first waveguide and be positioned to project into the first waveguide during formation of the first waveguide.

### PREFERRED FEATURES OF THE INVENTION

In one embodiment of the invention the effective refractive index of the device is increased by forming the second core with a region which is tapered to provide an increasing cross-sectional area with progression into the second core. In a second embodiment of the invention the effective refractive index of the device is increased by forming the second core such that its composition changes to increase the refractive index n₂ with progression into the second core. The photonic signal in progressing into the second waveguide will, in the respective embodiments, experience a gradual increase of the cross-sectional dimensions of the second core within the tapered region or a gradual increase in the material refractive index, this resulting in efficient transfer of the photonic signal into the second core. Conversely, a photonic signal propagating in the opposite direction through the device (from the second waveguide to the first waveguide) will experience a gradual decrease in effective refractive index, resulting in an efficient transfer of the signal from the second core into the first core.

As a consequence of projecting the second core into the first core and gradually increasing the effective refractive index, as above defined, the distance over which the effective refractive index is required to change is minimised.

In the first embodiment the tapered region may be tapered 2-dimensionally or 3-dimensionally. That is, the tapered region may be tapered in thickness toward a marginal line. Alternatively, the tapered region may be tapered in width toward a marginal line, or be tapered in both thickness and width toward a point.

In the second embodiment the second core may be formed such that the effective increase in the refractive index n₂ is achieved by providing a region in which the refractive index is gradually increased from substantially n₁ to n₂.

When the first core has a greater cross-sectional area than that of the second core, the second core may additionally include a region having a cross-sectional area which gradually reduces (with progression toward the second core) in a region adjacent the second core. This embodiment squeezes a photonic mode before it interacts with the second core and facilitates a further reduction in the distance over which the effective refractive index of the device is required to change.

The light propagation axes of the first core and the second core may be positioned in displaced relationship. This embodiment will be of advantage if the second core is composed of a material that requires higher processing temperatures than that which may be withstood by the material of the first core. In this case, the second core might be prepared as a first step and the first core then be deposited upon the second waveguide.

Alternatively, the second core may project into the first core with its light propagation axis coincident with the light propagation axis of the first core. A single-mode photonic signal guided in the first core will have its highest intensity in the centre of the waveguide and, if the axes of light propagation coincide, the signal transfer will be more efficient. This of particular advantage in the case of coupling materials with large refractive index differences.

The second core may comprise a plurality of layers. Each of the layers may itself have a cross-sectional area that is tapered and each of the successively higher layers (in the direction away from the first core) may also have an average refractive index higher than that of its preceding (lower) layer. In a preferred embodiment each of the successively higher layers is both tapered and has an average refractive index higher than that of its preceding layer.

In the photonic signal transmitting device the first and the second cores may be separated by an intermediate layer of a material that facilitates fabrication of the device. The intermediate layer preferably comprises a material that can easily be etched, such as amorphous or polycrystalline silicon, to permit forming tapered regions with relatively sharp tips.

The first core preferably is composed of a material based on silica. The second core may be composed of one or more of a metal-oxide, metal-nitrate and metal-sulphide. The second core is preferably composed of one or more of Al₂O₃, ZnO and a titanate of Perovskitc structure such as PLZT.

Each of the first and second cores may itself be formed from a plurality of sub-cores.

The first and second waveguides may be planar waveguides. Alternatively, the first and second waveguides may be optical fibres.

The method of fabricating the photonic signal transmitting device may comprise shaping the first and second cores by lithographically-defined etching.

The method may also comprise depositing waveguide materials by chemical vapour deposition, more specifically plasma-enhanced chemical vapour deposition. Alternatively, at least some of the waveguide materials may be deposited by sputtering. Advantageously, the sputtering comprises reactive dc magnetron sputtering. Further, the method may comprise the step of forming the second core with a doped zone which may optionally comprise masking a portion of the second core.

Preferred embodiments of the photonic signal transmitting device will now be described, by way of example only, with reference to the accompanying drawings.

### BRIEF DESCRIPTION OF THE DRAWINGS

In the drawings:

FIG. 1 shows a cross-sectional diagrammatic view of a first embodiment of cores of the device with the axes of light propagation of the first and second cores being coincident

FIG. 2 shows a diagrammatic plan view of one form of the first embodiment of the device as viewed in the direction of Arrow 2 in FIG. 1,

FIG. 3 shows a cross-sectional diagrammatic view a second embodiment of core portions of the device with the axes of light propagation of the first and second cores being displaced and with the second core being located wholly inside the boundary of the first core,

FIG. 4 shows a cross-sectional view of a variation of the second embodiment of the device with the second core located in part outside the boundary of the first core,

FIG. 5 shows a plan view, of a portion of the second core during formation by a doping process,

FIG. 6 shows a cross-sectional view of the arrangement illustrated in FIG. 5, as viewed in the direction of section plane 6-6,

FIG. 7 shows a plan view of the second core portion as illustrated in FIGS. 5 and 6 following the formation process,

FIGS. 8, 9, 10 and 11 show perspective views of alternative shapes of the second core,

FIG. 12 shows a plan view of a portion of a second core that is similar to that shown in FIG. 8 during formation by a doping process, and

FIG. 13 shows a plan view of the second core portion as illustrated in FIG. 12 following the formation process.

### DETAILED DESCRIPTION OF THE PREFERRED EMBODIMENTS

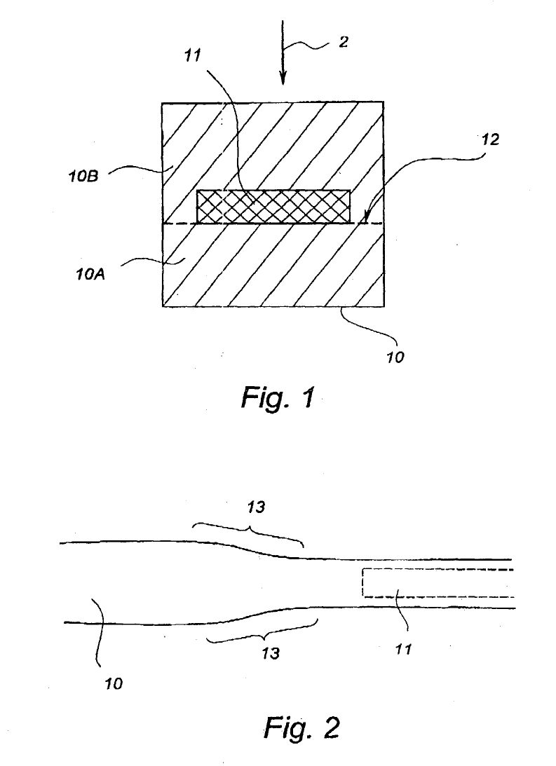

FIG. 1 shows a first embodiment of cores of the, device in which the square area 10 represents the cross-sectional area of a first core and the rectangular area 11 represents the cross-sectional area of a second core. In this embodiment, the axes of light propagation of the first and second cores coincide and are oriented in the direction perpendicular to the plane of the cross-section.

The preferred fabrication method for the embodiment of FIG. 1 involves an initial deposition of a first layer 10A of the silica-based first core 110. The thickness of the first layer 10A of the first core 10 is indicated by the dashed line 12. This layer, for example composed of germanium-doped silica (approx 10 mol % GeO₂), may be deposited on a silica buffer layer (not shown) by plasma-enhanced chemical vapour deposition (PECVD). The second core 11, in this example composed of aluminium oxide, is then deposited upon the layer 10A by a sputtering technique such as reactive DC magnetron sputtering and formed into the desired shape using photolithography and etching. A second layer 10B of the first core 10 is then deposited upon the shaped first core 11 and upon the first layer 10A. Photolithography and etching are then used to form the first and second layers 10A and 10B into the desired shape, resulting in the completed square first core 10.

The first core 10 may be narrowed in its cross-sectional dimensions in a tapered region 13 adjacent to the second core 11 as shown in FIG. 2.

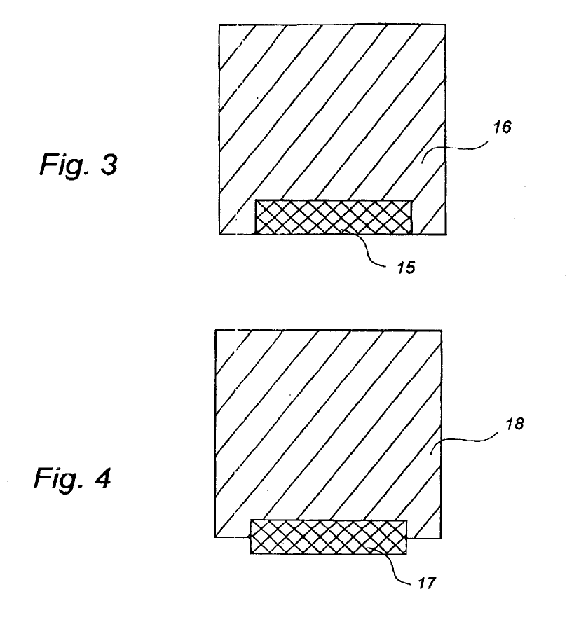

In a second embodiment, as illustrated in FIGS. 3 and 4, the axes of light propagation of the first and second cores are displaced. FIG. 3 shows a rectangular area and a square area representing the cross-sectional areas of the second core 15 and the first core 16 respectively. In this example the second core 15 is located wholly inside the boundary of the first core 16. FIG. 4 shows another embodiment in which the cross-sectional area of the second core 17 is located in part outside the boundary of the first core 18. For the embodiments shown in FIGS. 3 and 4, the preferred fabrication method involves initially depositing and shaping the second core, for example comprising aluminium oxide or PLZT. A silica-based layer is subsequently deposited upon the second core and etched into the desired waveguide geometry to form the first core.

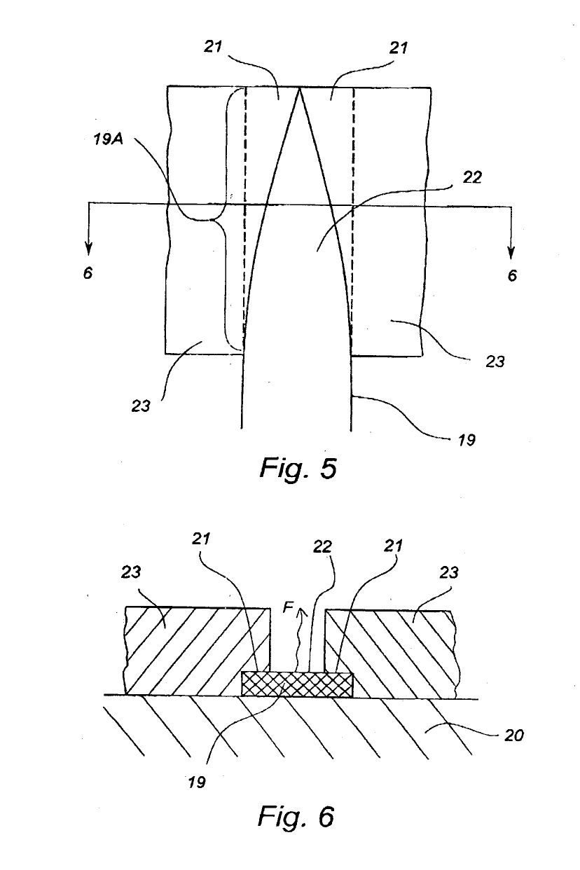

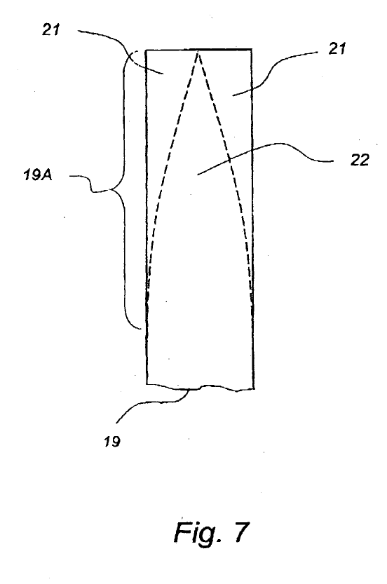

In an alternative embodiment, which is shown in FIGS. 5 to 7, an aluminium oxide core 19 doped with fluorine is first formed on a silica buffer layer 20. Fluorine is known to reduce the refractive index of aluminium oxide. A transitional region 19A is formed by masking a first zone 21 of the aluminium oxide core 19 such that a second zone 22 which forms a part of the transitional region 19A is exposed. The mask 23 in this embodiment comprises silica, but could comprise another material. The masked core is then exposed to heat which causes the exposed second zone 22 to outgas fluorine, whilst the masked first zone 21 is prevented from outgassing fluorine. The resultant structure, as shown in FIG. 7, comprises the second zone 22 composed of aluminium oxide which is lightly doped with fluorine, and the first zone 21 (which is masked during the heating stage) and is more heavily doped with fluorine. Thus, the average refractive index as measured across the width of the core increases progressively along the length of the core in the direction away from the terminal end of the core.

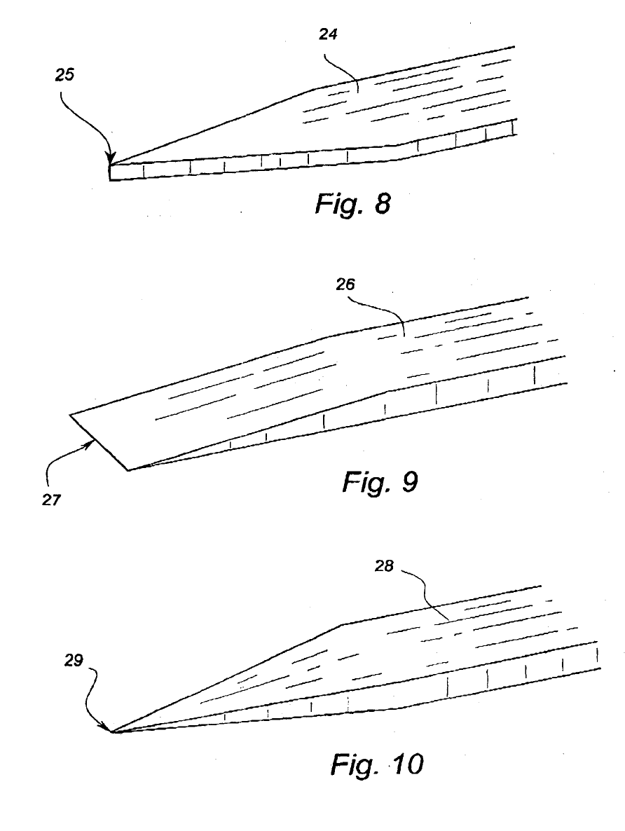

FIGS. 8, 9 and 10 show perspective views of possible configurations of the second core. FIG. 8 shows the second core 24 adiabatically tapered in width toward a vertical marginal line 25. FIG. 9 shows the second core 26 adiabatically tapered in thickness toward a horizontal marginal line 27. FIG. 10 shows another example in which the second core 28 is adiabatically tapered in both thickness and in width substantially toward a point 29.

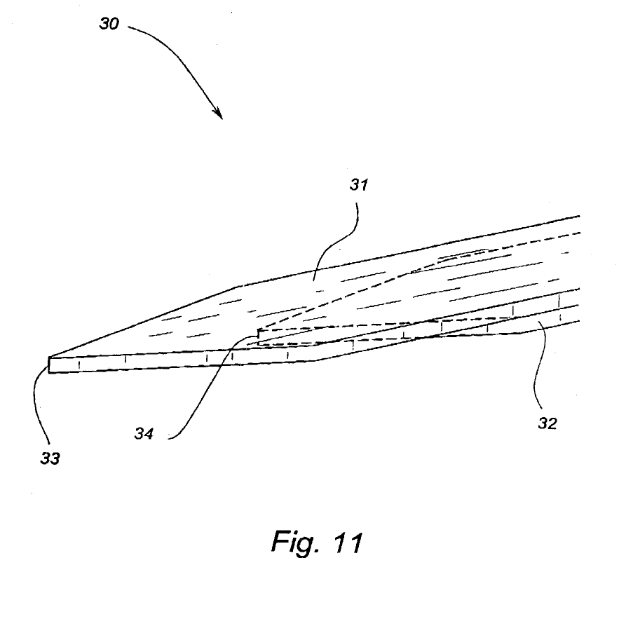

FIG. 11 shows a further example in which the second core 30 comprises an upper or inner layer 31 disposed above a preceding (lower or outer) layer 32, both of which are individually adiabatically tapered in width toward first and second vertical marginal lines 33 and 34, respectively. These layers may be composed of zinc-oxide (refractive index ˜2) and PLZT (refractive index ˜2.4) and may be fabricated using sputtering techniques. This embodiment is useful where there is a large difference in refractive index between the second core and the first core. For example, where the first core comprises a silica-based material (n˜1.5), a second core composed of an inner ZnO layer 31 and an outer PLZT layer 32 provides a crude grading in refractive index from silica-based material to PLZT since the layer of ZnO has a refractive index which is roughly half-way between the refractive indices of the PLZT and silica-based layers.

The second cores shown diagrammatically in FIGS. 8 to 11 may form part of any one of the examples shown in the first or the second embodiment (FIGS. 1 to 4). If the second core is tapered in width, the preferred fabrication method requires photolithographic and etching steps in addition to the respective methods of fabrication relating to the embodiments shown in FIGS. 1 to 4. If the second core is tapered in thickness, the preferred fabrication method requires the following steps in addition to the respective methods of fabrication relating to the embodiments shown in FIGS. 1 to 4. A concentration gradient of etching species is created along the direction of the taper, which can be achieved, for example, by using an appropriate shadow mask containing a suitable pattern. The mask is physically separate from the second core such that there is a gap between the mask and the substrate which determines the length of the tapered region.

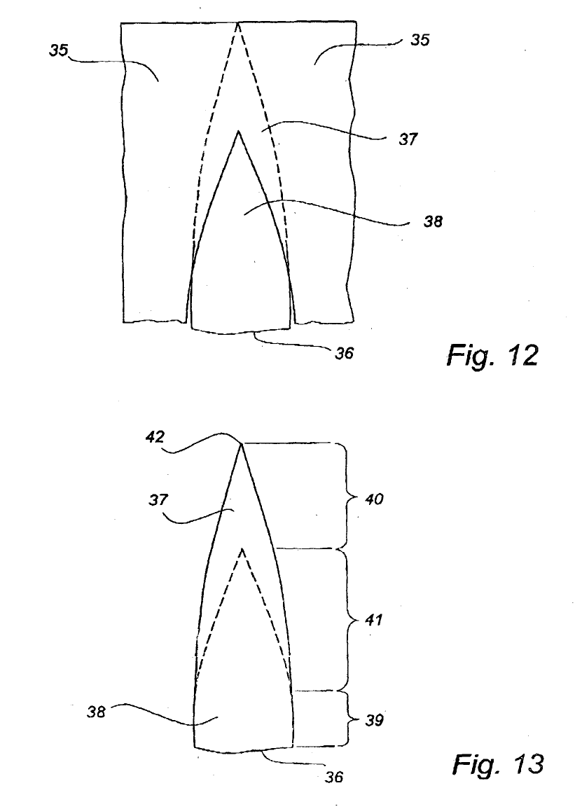

Reference is now made to FIGS. 12 and 13 which show an alternative process in which mask 35 is deposited over a tapered region of a fluorine-doped aluminium oxide second core 36 so as to cover a leading zone 37 of the tapered region and to expose a central zone 38 of the tapered region. The entire structure is exposed to heat, causing fluorine to outgas from the exposed central zone 38. Thus, the refractive index in the exposed central zone 38 increases. The resultant structure (FIG. 13) comprises a zone 39 of constant effective refractive index and a transitional region made up of a first zone 40 in which the cross-sectional dimensions of the core are tapered but in which the material refractive index is constant, and a second zone 41 in which both the refractive index is increased (relative to the first zone) and cross-sectional dimensions of the core me tapered. Thus, the effective refractive index gradually increases with progression from a terminal end 42 to the zone 39 of constant refractive index.

Although the invention has been described with reference to particular examples, it will be understood that variations and modifications may be made that fall within the scope of the appended claims.

It should also be understood that the above identified United States patent application do not constitute publications that form part of the common general knowledge in the art, in Australia or any other country.

We claim:

1. A photonic signal transmitting device which comprises:
a first waveguide having a first core composed of a first material having a refractive index n₁, and
a second waveguide having a second core composed of a second material having ant average refractive index n₂>n₁,
the second core being projected into the first core, and the second core being formed such that the effective refractive index of the device increases with progression into the second core from the first core.

2. The photonic signal transmitting device as claimed in claim 1 wherein the effective refractive index of the device is increased by forming the second core with a region which is tapered to provide an increasing cross-sectional area with progression into the second core.

3. The photonic signal transmitting device as claimed in claim 1 wherein the effective refractive index of the device is increased by forming the second core with a region in which the core material composition changes to increase the refractive index with progression into the second core.

4. The photonic signal transmitting device as claimed in claim 2 wherein the tapered region is formed as a two-dimensional taper.

5. The photonic signal transmitting device as claimed in claim 2 wherein the tapered region is formed as a three-dimensional taper.

6. The photonic signal transmitting device as claimed in claim 3 wherein the effective refractive index of the device is increased by forming the second core with a region in which the core material composition changes to increase the refractive index with progression into the second core and the refractive index is gradually increased from substantially n₁ to n₂.

7. The photonic signal transmitting device as claimed in claim 2 wherein the tapered region is tapered in thickness substantially toward a marginal line.

8. The photonic signal transmitting device as claimed in claim 2 wherein the tapered region is tapered in width substantially toward a marginal line.

9. The photonic signal transmitting device as claimed in claim 2 wherein the tapered region is tapered in thickness and width substantially toward a point.

10. The photonic signal transmitting device as claimed in claim 2 wherein the cross-sectional area of the first core is gradually reduced with progression toward the second core in a region adjacent the tapered region of the second core.

11. The photonic signal transmitting device as claimed in claim 1 wherein the light propagation axes of the first core and the second core are located in displaced relationship.

12. The photonic signal transmitting device as claimed in claim 1 wherein the light propagation axes of the first core and the second core are coincident.

13. The photonic signal transmitting device as claimed in claim 1 wherein the second core comprises a plurality of layers.

14. The photonic signal transmitting device as claimed in claim 13 wherein each of the layers itself has a cross-sectional area that is tapered.

15. The photonic signal transmitting device as claimed in claim 13 wherein each of the successively higher layers (in the direction away from the first core) has an average refractive index that is higher than that of its preceding layer.

16. The photonic signal transmitting device as claimed in claim 13 wherein each of the layers itself has a cross-sectional area that is tapered and each of the successively higher layers (in the direction away from the first core) has an average refractive index that is higher than that of its preceding layer.

17. The photonic signal transmitting device as claimed in claim 1 wherein the first and the second cores are separated by an intermediate layer of a material that facilitates fabrication of the device.

18. The photonic signal transmitting device as claimed in claim 17 wherein the intermediate layer comprises a material that facilitates etching.

19. The photonic signal transmitting device as claimed in claim 18 wherein the intermediate layer material comprises amorphous silicon.

20. The photonic signal transmitting device as claimed in claim 1 wherein the first core is composed of a silica-based material.

21. The photonic signal transmitting device as claimed in claim 1 wherein the second core is composed of at least one of a metal oxide, metal nitrate and metal sulphide.

22. The photonic signal transmitting device as claimed in claim 1 wherein the second core is composed of at least one of Al₂O₃, ZnO and a titanate of Perovskite structure.

23. The photonic signal transmitting device as claimed in claim 22 wherein the second core comprises PLZT.

24. The photonic signal transmitting device as claimed in claim 1 wherein each of the first and second cores is itself formed from a plurality of sub-cores.

25. The photonic signal transmitting device as claimed in claim 1 wherein the first and second waveguides are planar waveguides.

26. The photonic signal transmitting device as claimed in claim 1 wherein the first and second waveguides are optical fibres.

27. A method of forming a photonic signal transmitting device, the method comprising the steps of:
forming a first waveguide with a first core composed of a first material having a refractive index n₁,
and forming a second waveguide with a second core projecting into the first core, the second core being composed of a second material having an average refractive index n₂>n₁ and being formed such that the effective refractive index of the device increases with progression from the first core into the second core.

28. The method as claimed in claim 27 wherein the second core is formed prior to the first core.

29. The method as claimed in claim 27 wherein at least one of the first and second cores is shaped by a lithographically-defined etching process.

30. The method as claimed in claim 29 wherein the lithographically-defined etching process includes photo-lithography.

31. The method as claimed in claim 27 wherein at least one of the first and second cores is formed by chemical vapour deposition.

32. The method as claimed in claim 31 wherein the chemical vapour deposition process comprises plasma-enhanced chemical vapour deposition.

33. The method as claimed in claim 27 wherein at least one of the first and second cores is formed by sputtering.

34. The method as claimed in claim 33 wherein the sputtering process comprises reactive dc sputtering.

35. The method as claimed in claim 27 wherein the step of forming the second core comprises establishing a roped zone.

36. The method as claimed in claim 35 wherein establishing the doped zone comprises masking a portion of the second core.
